(19) United States
(12) Patent Application Publication
(10) Pub. No.: US 2005/0109034 A1
(43) Pub. Date: May 26, 2005

(54) Method for operation of a power generation plant

(76) Inventors: Rolf Althaus, Flawil (CH); Martin Koller, Baden (CH); Karl Wiederhold, Bruchsal (DE)

Correspondence Address: COLLIER SHANNON SCOTT, PLLC, 3050 K STREET, NW, SUITE 400, WASHINGTON, DC, 20007, US

(21) Appl. No.: 10/934,471

(22) Filed: Sep. 7, 2004

Related U.S. Application Data
(63) Continuation-in-part of application No. PCT/CH03/00431, filed on Jun. 30, 2003.

(30) Foreign Application Priority Data
Jul. 4, 2002 (CH) 2002 1177/02
Oct. 23, 2003 (CH) 2003 1812/03

(51) Int. Cl. F02C 7/00

(52) U.S. Cl. 60/772; 60/727

(57) ABSTRACT

A CAES plant comprises an atmospheric combustion chamber situated downstream from the expansion machine. The flue gas produced in the process passes through a heat exchanger. In the heat exchanger, the storage fluid, which flows to the expansion machine from the storage, is heated by heat exchange. In the inventive power plant, the storage fluid is used directly for combustion of a fuel without exposing the expansion machine to corrosive flue gases.

### CROSS-REFERENCE TO RELATED APPLICATIONS

This application is a continuation-in-part of the U.S. National Stage designation of co-pending International Patent Application PCT/CH03/00431 filed Jun. 30, 2003, the entire content of which is expressly incorporated herein by reference thereto. This application also claims priority to Swiss application no. 2002 1177/02 filed Jul. 4, 2002 and Swiss application no. 2003 1812/03 filed Oct. 23, 2003, the entire contents of which are expressly incorporated herein by reference thereto.

### FIELD OF THE INVENTION

The present invention relates to a power plant and a preferred method of operation.

### BACKGROUND OF THE INVENTION

CAES power plants are sufficiently well known in the state of the art, e.g., from U.S. Pat. No. 5,537,822. In these power plants, a storage volume is filled with a compressed storage fluid, in particular air. At times of peak power demand, the stored fluid is expanded in a power engine to produce energy which drives a generator. At a given pressure ratio across the power engine, the utilization of the storage fluid is greater, the higher the temperature of the storage fluid at the inlet to the power engine.

U.S. Pat. No. 5,537,822 proposes depressurizing the storage fluid in several steps, and it proposes heating the fluid before each expansion step. This requires complex equipment because multiple power engines and multiple heat exchangers must be in fluid connection in series. As an alternative, U.S. Pat. No. 5,537,822 proposes heating the storage fluid before it expands in the power engine by using the waste heat of a gas turbo group. This requires the installation and operation of a gas turbo group.

### SUMMARY OF THE INVENTION

The present invention seeks to remedy this situation. The invention relates to providing a power plant that is capable of avoiding the disadvantages of the prior art. In particular, this invention relates to providing a CAES power plant in which the storage fluid can be brought to the highest possible temperature prior to expansion without requiring complex secondary equipment. Likewise, the arrangement of additional flues should be avoided because the number of flues is often strictly limited under the terms of the building and operating permits.

The invention thus involves the design of a power plant so that the storage fluid in the power engine is basically expanded completely, i.e., essentially to atmospheric pressure, and then flows through an atmospheric combustion chamber, where a fuel is burned in the expanded storage fluid, and the flue gas formed by this combustion flows through the primary side of a heat transfer apparatus, where it is cooled by heat exchange with the storage fluid entering the power engine. Then the cooled flue gas flows out as an exhaust gas. The storage fluid removed from the storage volume is heated in the power engine prior to expansion, resulting in an increase in the available mass-specific enthalpy gradient across the power engine. In other words, a lower storage fluid mass flow is necessary, or conversely, more electric power is generated with a given storage pressure and volume. Air is suitable in particular as the storage fluid because it is available to a virtually unlimited extent and can be used with no problem for burning a fuel in the atmospheric combustion chamber.

The inventive arrangement is characterized by several advantages: first, the storage fluid is used directly for combustion of the fuel. This has the advantage that complex equipment for conveying combustion air is eliminated because the expanded storage fluid must flow through an exhaust line of the power engine anyway. Furthermore, it is possible to eliminate an additional flue to be set up next to an exhaust air flue. On the other hand, combustion only takes place downstream from the power engine, and the storage fluid entering the power engine is heated in indirect heat exchange. This means that the power engine has storage fluid flowing through it, and this fluid is usually air instead of corrosive flue gases. It is thus possible to eliminate any protective measures against corrosive flue gases. Therefore, it is possible to use very low-cost power engines than would be the case if the power engines were to be exposed to flue gases. In particular, with slight modifications, steam turbines can be used as the expansion engines for the storage fluid. It is advantageous here if the inlet temperature of the storage fluid is limited to remain compatible with the admissible inlet temperatures of the turbine of, for example, approximately 500° C. to 600° C. or even 650° C. without the use of high-temperature materials. A turbine which is provided for expansion of a non-corrosive storage fluid and therefore does not require special measures for protection against aggressive and corrosive media is hereinafter referred to simply as an air turbine.

The inventive power plant can be implemented very advantageously and at a low cost with precisely a single expansion engine. In an advantageous embodiment, the secondary-side flow path of the heat transfer apparatus through which pressurized storage fluid flows is essentially in direct fluid connection with the high-pressure side of the expansion engine, such that the heated storage fluid flows to the expansion machine without flowing through additional units. In addition, an essentially direct fluid connection of the low-pressure side of the expansion engine to the atmospheric combustion chamber is established to advantage in precisely this sense. Another advantage is the obligatory compatibility of the fluid mass flows through the heat transfer apparatus on the primary and secondary sides on the basis of which the temperature conditions at the inlet and outlet of the heat exchanger apparatus are essentially only a function of its dimensions.

It is extremely advantageous to provide a flue gas purification catalyst downstream from the atmospheric combustion chamber. On the basis of the temperature window required for the function of the catalyst, it is advantageously situated within the heat transfer apparatus, namely at a point where the flue gases coming from the atmospheric combustion chamber have cooled far enough in heat exchange with the pressurized storage fluid to prevent damage to the catalyst while still having a temperature suitable to ensure an adequate catalytic effect. In other words, the catalyst is situated downstream from the first part of the primary-side flow path and upstream from the second part within the primary-side flow path of the heat transfer apparatus.

In addition, in another embodiment of this invention, a high-pressure combustion chamber is situated downstream from the secondary-side flow path of the heat transfer apparatus and upstream from the expansion machine. This permits a further increase in the mass flow-specific power output, but it requires appropriate measures involving the expansion machine on the other hand because then corrosive flue gases flow through it and the components are exposed to higher temperatures. Then in this case the turbine part of a gas turbo group may preferably be used as the expansion engine. In this embodiment, at the inlet of the expansion machine is determined directly or indirectly, preferably in a known suitable manner, and the fuel mass flow to the high-pressure combustion chamber is controlled by adjusting a fuel mass flow control element to keep this temperature at a setpoint or to limit this temperature to an allowed maximum.

In one mode of operation of the inventive power plant, the useful output power of the expansion engine is preferably regulated by influencing the storage fluid mass flow. This requires suitable means for determining the useful output power, preferably as the power of a generator driven by the expansion engine. Preferably using the power thus determined as a controlled variable, a power regulator is operated to intervene as a manipulated variable on a storage fluid mass flow control element.

In another mode of operation, the storage fluid temperature at the inlet to the expansion machine is determined directly or indirectly by a suitable method and is regulated by acting on a fuel mass flow control element of the atmospheric combustion chamber.

In another advantageous mode of operation, the temperature of a flue gas purification catalyst located in the flue gas path downstream from the atmospheric combustion chamber and/or the temperature of the flue gas inflow to this catalyst, whereby regulation may of course also be understood to include setpoint regulation as well as limit value regulation. A continuous-action regulator as well as a discontinuous-action controller, e.g., a two-point regulator, may also be used. Such a regulator or controller ensures that the catalyst will not be damaged permanently due to overheating. In addition, the temperature may be regulated within a temperature window that promotes catalytic flue gas purification.

In yet another advantageous embodiment, the temperature of the flue gas is determined downstream from the primary-side flow path of the heat transfer apparatus or at its outlet and is regulated at a setpoint or at maintaining an allowed minimum. This makes it possible to ensure first that the temperature will not fall below the dew point of corrosive flue gas components. In this regard, the lower limit temperature may also vary depending on the fuel and may be higher with oil firing, for example, than with natural gas firing. In one mode of operation the flue gas temperature may be regulated at the lowest possible value above this dew point, thereby minimizing exhaust heat losses and thus improving fuel utilization.

Other advantageous embodiments of the inventive power plant and advantageous modes of operation are derived from the exemplary embodiments.

### BRIEF DESCRIPTION OF THE DRAWINGS

The invention is explained in greater detail below on the basis of exemplary embodiments illustrated in the drawings, showing in particular:

FIG. 1 shows a first preferred embodiment of the invention;

FIG. 2 shows another preferred embodiment of the invention;

FIG. 3 shows an electricity network with a storage power station that can be operated in connection with the invention; and

FIG. 4 shows an example embodiment of a storage power station that can be operated in connection with the invention.

Elements not directly necessary for an understanding of this invention are omitted. The exemplary embodiments are to be understood from a purely instructive standpoint and should not be used to restrict the invention.

### DETAILED DESCRIPTION OF THE PREFERRED EMBODIMENTS

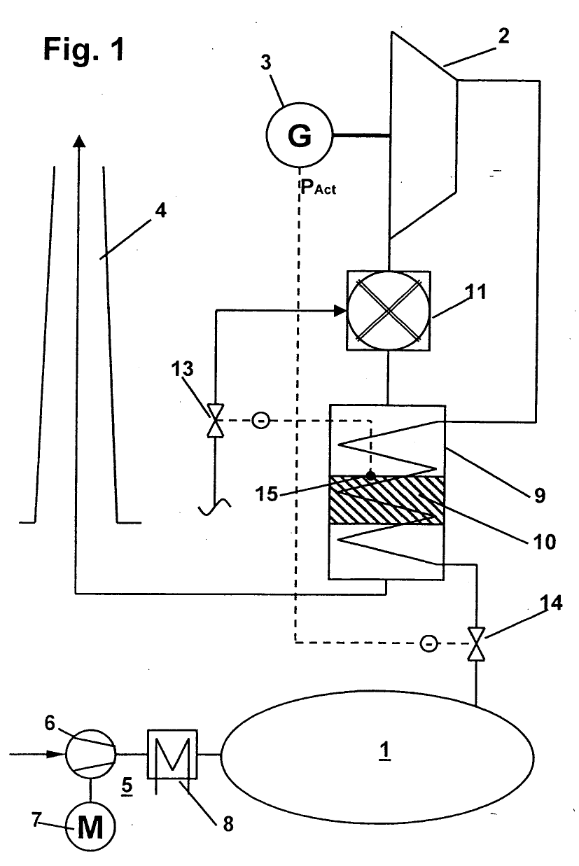

The power plant depicted in FIG. 1 comprises fundamentally a storage volume 1 for storage of a compressed gas, in particular air, and a turbine 2 for expansion of the storage fluid in a work-producing process, which drives a generator 3 that generates a useful output power P_{Act}. The expanded storage fluid is discharged into the atmosphere through an exhaust flue 4. For loading the storage 1, a compressor unit 5 is provided, although its specific design is not relevant to this invention. A turbocompressor 6 with a drive motor 7 and a condenser 8 are shown as an example. In times of low electric power demand and low electricity price rates accordingly, the compressor unit is operated to load the storage 1 with compressed air. As mentioned in the introduction, and as is easily reproducible, the specific enthalpy gradient over the turbine is very low if air flows from the storage to the turbine 2 and is expanded at approximately ambient temperature. In other words, to generate a certain electric power, a great deal of storage fluid is required; in other words, the electric power generable at a predetermined storage pressure using a given stored volume is limited by this factor. Therefore, a heat transfer apparatus 9 and a combustion chamber 11 are provided according to this invention. The combustion chamber 11 is located downstream from the turbine 2. Apart from the dynamic pressure of the incoming fluid and pressure drops in the remaining flow path, the pressure of the storage fluid in the combustion chamber 11 corresponds to ambient pressure. It is therefore justified to speak of an atmospheric combustion chamber. The heat transfer apparatus 9 is configured in such a way that the flow path on the primary side through which a heat-releasing fluid flows is situated in the flow path of the expanded storage fluid downstream from the atmospheric combustion chamber 11. The flow path on the secondary side through which flows the fluid that absorbs heat is situated between the storage 1 and the turbine 2 in the flow path of the storage fluid. In other words, the same fluid flow passes through both the primary side of the heat transfer apparatus 9 and the secondary side of the heat transfer apparatus 9. In the atmospheric combustion chamber 11, fuel is supplied to the expanded working fluid and burns it. The resulting hot flue gas is sent to the heat transfer apparatus 9 and is cooled with the storage fluid flowing out of the storage volume 1 and to the turbine 2 in heat exchange as it flows through the apparatus. At the same time, the fluid flowing from the storage to the turbine on the secondary side is heated by heat exchange. The fluid flows on the primary side and the secondary-side flow in countercurrent in the interest of achieving the best heat exchanger effect. Because of the heating of the storage fluid before it enters the expansion engine 2, a greater mass-specific enthalpy gradient is available. Accordingly, at a certain pressure ratio, a lower mass flow is necessary to generate a certain useful output power and more electric power can be generated with the storage fluid stored in a predetermined storage volume. With regard to the power yield, it is of course all the more favorable, the higher the temperature of the storage fluid at the inlet into the storage fluid expansion machine 2. On the other hand, there are limits to the maximum allowed temperature due to the materials used as well as other boundary conditions. It is therefore highly advantageous to determine the temperature at the inlet to the expansion machine 2 by suitable means and to limit it to a maximum or to regulate it at a setpoint as close to this maximum as possible. One possible implementation of this regulation is explained in greater detail below.

This invention thus makes it possible to heat the storage fluid before it enters the expansion engine without exposing the power engine to a flue gas flow. In addition, only the storage fluid, in particular air, flows through the power engine. In the embodiment depicted here, the components of the expansion machine are not exposed to corrosive flue gas components, so the expansion machine can be implemented more easily and less expensively. Likewise essentially only a single media flow and only one flue are necessary, because the storage fluid is at the same time used to burn the fuel. In addition, no special equipment need be provided for processing and conveying combustion air to an external furnace. Pollution components such as nitrogen oxides are formed by combustion of a fuel. Although the pollution levels can be reduced greatly by suitable measures in combustion, the strictest emission regulations require the use of exhaust gas processing measures. In the embodiment depicted here, a flue gas purification catalyst 10 is provided in the flue gas flow path downstream from the atmospheric combustion chamber. When using a flue gas purification catalyst, its operating temperature window must be noted. If the catalyst temperature is too high, it will result in irreversible damage to the catalyst. If the temperature is too low, no catalytic effect is achieved. The temperature of the flue gas at the outlet from the atmospheric combustion chamber is in general too high for the catalyst. For the best utilization of heat, the flue gas in the heat transfer apparatus 9 is cooled to a temperature that is too low for catalytic exhaust gas purification. Therefore the catalyst is situated inside the heat transfer apparatus in the primary-side flow path downstream from a first part of the flow path and upstream from a second part of the flow path within the heat transfer apparatus. In this way the temperature gradient across the heat transfer apparatus is advantageously divided in such a manner that a favorable temperature range for the catalyst prevails in normal operation. This effect may also be achieved equivalently by dividing the heat transfer apparatus into two zones with the catalyst being inserted in between.

In the embodiment depicted here, a storage fluid mass flow control element 14 is used as the control element to regulate the useful output power. The useful output power is determined as the generator power P_{Act}. This is compared with a setpoint by a method, which is not shown here but is nevertheless readily familiar to those skilled in the art. When there is a drop in power as a controlled variable, control element 14 is opened further and the storage fluid mass flow increases. When there is an increase in power as a controlled variable, the control element 14 is throttled to a greater extent and the storage fluid mass flow decreases.

The mass flow of fuel supplied to the atmospheric combustion chamber 11 is available as an additional manipulated variable of the process, which is controlled by the fuel mass flow control element 13. Essentially three temperatures are relevant for operation of the power plant depicted here. These include first, the temperature of the storage fluid at the outlet from the secondary-side flow path of the heat transfer apparatus or the temperature of the storage fluid at the inlet to the turbine 2, the exhaust gas temperature of the fluid at the outlet from the primary-side flow path of the heat transfer apparatus and the catalyst temperature or the temperature of the flue gas immediately upstream from the catalyst. According to one aspect of this invention, the power plant has means for determining one of these temperatures which is used as a controlled variable for a control circuit, while the position of the fuel mass flow control element 13 is used as a manipulated variable for this control circuit. The question that arises now as a process optimization question is which of the three temperatures is regulated at a setpoint. If the temperature at the turbine inlet is regulated at the highest possible setpoint, the result is a mode of operation with the best utilization of storage fluid. If the temperature of the flue gas is regulated at a setpoint downstream from the heat transfer apparatus, the exhaust gas heat losses can be minimized, resulting in efficiency-optimized operation. In the embodiment depicted here, the temperature of the catalyst is measured by means of a measurement point 15 and is regulated at a setpoint. If the measured temperature exceeds the setpoint or the upper limit of a setpoint interval, the control element 13 is closed a certain amount. If the measured temperature falls below the setpoint or the lower limit of a separate interval, the control element 13 is opened a bit more. This results in a best possible flue gas purification effect of the catalyst. The mass flows on the primary and secondary sides of the heat transfer apparatus are necessarily always identical except for the fuel mass flow. At given dimensions of the heat transfer apparatus, all three temperatures are therefore closely linked together. In other words, when one of the three temperatures is regulated at a setpoint, the fluctuations in the two other temperatures vary within comparatively narrow limits. In other words, the other temperatures are also regulated indirectly. It is likewise advantageous to monitor the temperatures that are not regulated directly by using methods not depicted here but with which those skilled in the art are familiar and to analyze these temperatures in a safety circuit of the power plant so that in the embodiment depicted here, the flue gas does not drop below the dew point and thermal overloading of the expansion machine is avoided.

In principle it is also possible to provide another combustion chamber downstream from the secondary-side flow path of the heat transfer apparatus 9 and upstream from the turbine 2. Providing indirect firing at this location is not advisable in the inventive embodiment of the power plant although in principle it is possible. This configuration of a combustion chamber upstream from the turbine 2 requires special measures, however, to prevent damage to the turbine, which is exposed to hot flue gases. In this case in particular the expansion turbine of a gas turbo group may be used and is also combined to advantage with its combustion chamber. For the sake of simplicity, however, according to a first aspect of this invention, the embodiment depicted in FIG. 1 in which the flow path from the secondary side of the heat transfer apparatus 9 to the expansion engine is implemented essentially directly, i.e., without any units connected in between, is considered advantageous.

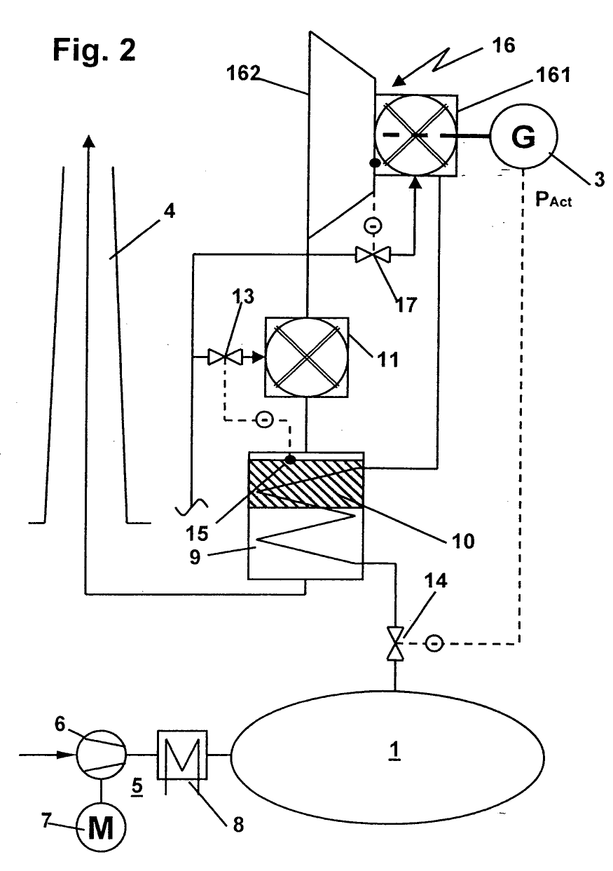

The arrangement of a combustion chamber upstream from the expansion machine is implemented advantageously in the manner depicted in FIG. 2. This makes use of the fact that an operating temperature window of a catalyst from about 300° C. to 350° C., for example, is quite comparable to a final compressor temperature of a gas turbo group with a pressure ratio between 10 and 15, but these temperatures may also be much higher with specific catalysts. In the power plant depicted in FIG. 2, the catalyst 10 is situated at the upstream end of the primary-side flow path of the heat transfer apparatus 9. In addition, the power plant includes a combustion chamber turbine unit 16 comprising the combustion chamber 161 and the turbine 162 of a gas turbo group in which the compressor has been omitted. In a manner not depicted here, a portion of the storage fluid is diverted into the cooling air system of the gas turbo group upstream from the high-pressure combustion chamber 161. It is also highly advantageous here that this storage fluid has a temperature which is at least approximately comparable to that of cooling air diverted at a compressor outlet of a gas turbo group. The shaft end on the compressor side drives the generator 3 directly. The power of the generator power P_{Act} is regulated with the position of the storage fluid mass flow control element 14 as the manipulated variable. The temperature of the catalyst is advantageously regulated with the position of the fuel mass flow control element 13 of the atmospheric combustion chamber as a manipulated variable. The temperature at the inlet to the turbine 162 is not measured directly in the present embodiment but instead is calculated in a known way from other variables, e.g., the turbine outlet temperature and the turbine pressure ratio. The temperature thus determined is regulated by means of measures influencing the fuel mass flow control element 17 of the combustion chamber 161. In this way it is also possible to construct an inventive power plant using mostly standardized components, namely the complete combustion chamber turbine unit 16.

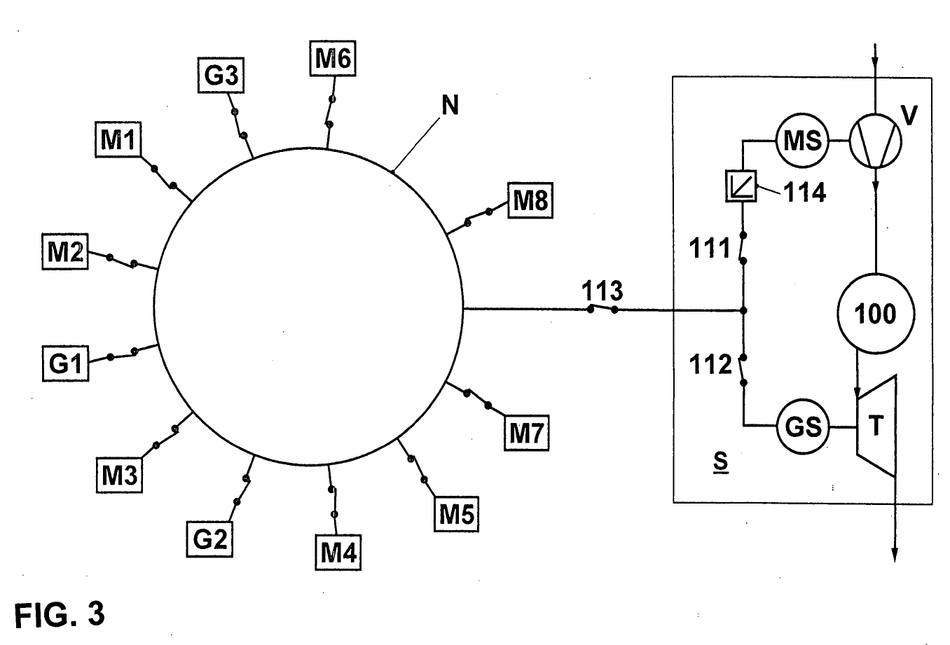

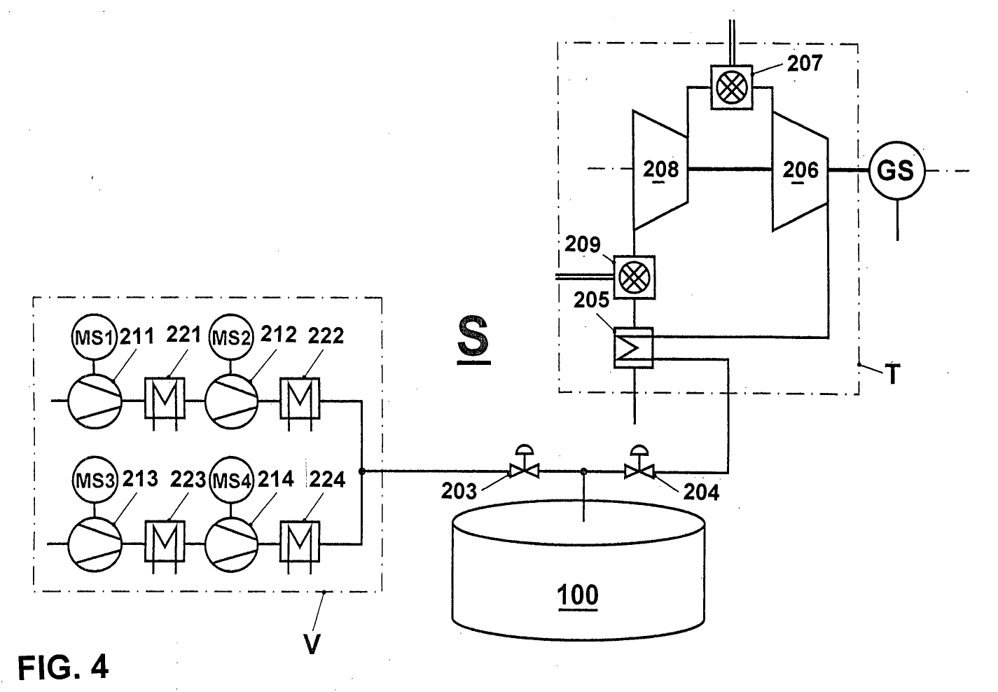

An exemplar storage power station S for use with the present invention is illustrated highly schematically in FIG. 3. FIG. 4 shows an example of an embodiment of a storage power station S. The process machine, the compressor, V in this case comprises two compressor runs each having two compressors and two coolers. In each compressor run, a first compressor 211 or 213 compresses air to an intermediate pressure. The air is cooled at an intermediate stage in a cooler 221 or 223 and is compressed in a second compressor 212 or 214 to a final pressure, which is typically in the range from 30 to 100 bar or 50 to 100 bar. The compressors are driven by drive motors MS1, MS2, MS3 and MS4. The compressed air flows through a throttling and shut-off member 203 into the storage volume 100. Stored air flows via a throttling and shut-off member 204 to the turbine unit T. Within this turbine unit T, the air first of all flows through an exhaust gas heat exchanger 205 where, for example, it is heated to 550° C. After this, the air is expanded in an air turbine 206 to a pressure of around 10 to 15 bar. The state of the air at the outlet from the air turbine 206 is normally comparable to the state at the compressor outlet from a gas turbine group. For this reason, the combustion chamber 207 and the turbine 208 of a gas turbine group can be arranged very particularly advantageously downstream from the air turbine. A fuel is burnt in the air in a manner known per se in the combustion chamber 207, resulting in the production of a compressed hot gas, which is expanded approximately to the environmental pressure in the turbine 208, carrying out work in the process. The expanded hot gas is optionally reheated in a further burner 209, and then flows through the exhaust gas heat exchanger 205, in which the residual heat from the exhaust gas is transferred to the supply air to the air turbine 206. The air turbine 206 and the gas turbine 208 of the turbine unit are arranged on a common shaft and drive the generator GS. In contrast to a conventional gas turbine group, the compressor and turbine are mechanically completely decoupled from one another and, owing to the intermediate storage volume in the flow path, the fluid-mechanical coupling also has a certain amount of elasticity. This makes it possible for the turbine unit T and the compressor unit V to be operated independently of one another, such that, as described above, it is possible to react very highly flexibly to different power demands by means of two mechanisms, namely via the power consumption of the compressor unit and the power output of the turbine unit, and to increase the net power output virtually instantaneously, in particular by shutting down power-consuming compressors. In this case, the compressor runs, which are arranged in parallel with the mass flow, can likewise be controlled independently of one another, thus further simplifying the power control for the entire storage plant S.

List of Reference Notations

1 storage volume, compressed air storage
2 expansion engine, expansion turbine
3 generator
4 flue, exhaust air flue
5 compressor unit
6 compressor
7 driving motor
8 Condenser
9 heat transfer apparatus
10 flue gas purification catalyst
11 atmospheric combustion chamber
13 fuel mass flow control element
14 storage fluid mass flow control element
15 temperature measurement point
16 combustion chamber turbine unit
17 fuel mass flow control element
161 combustion chamber, high-pressure combustion chamber
162 turbine
P_{Act} useful output power
203 Shut-off and throttling member
204 Shut-off and throttling member
205 Heat exchanger, exhaust gas heat exchanger, recuperator
206 Air turbine
207 Combustion chamber
208 Gas turbine
209 Additional firing
211 Compressor
212 Compressor
213 Compressor
214 Compressor
221 Intercooler
222 Air cooler
223 Intercooler
224 Air cooler
100 Storage volume
111 Switch
112 Switch
113 Mains switch
114 regulator
G1, G2, G3 Power stations
GS Generator for the power source in the storage power station
M1, M2, M3, M4, M5, M6, M7, M8 Loads
MS Drive motor for the process machine for the storage power station
MS1, MS2, MS3, MS4 drive motors for the process machine for the storage power station
S Storage power station
T Turbine unit, power source
V Compressor unit, process machine

1. A power plant comprising a pressure storage area for a compressed gaseous storage fluid, an expansion power engine with a power engine inlet on a high-pressure side and a power engine outlet on a low-pressure side, a heat transfer apparatus comprising a flow path on a primary side that releases heat and a flow path on a secondary side that takes up heat, and an atmospheric combustion chamber, wherein:
an upstream end of the secondary side flow path of the heat transfer apparatus is connected to the pressure storage area;
a downstream end of the secondary side flow path of the heat transfer apparatus is connected to the power engine inlet;
the power engine outlet is connected to an upstream end of the atmospheric combustion chamber; and
a downstream end of the atmospheric combustion chamber is connected to an upstream end of the primary side flow path of the heat transfer apparatus.

2. The power plant of claim 1, wherein the compressed gaseous storage fluid is compressed air.

3. The power plant of claim 1, comprising exactly one expansion engine.

4. The power plant of claim 1, wherein the secondary side flow path of the heat transfer apparatus is in substantially direct fluid communication with the high-pressure side of the expansion power engine.

5. The power plant of claim 4, wherein the expansion power engine is an air turbine.

6. The power plant of claim 1, wherein the low-pressure side of the expansion power engine is in substantially direct fluid communication with the atmospheric combustion chamber.

7. The power plant of claim 1, wherein a catalyst for exhaust gas purification is provided in the primary side flow path of the heat transfer apparatus.

8. The power plant of claim 7, wherein the catalyst is disposed downstream from a first part of the primary side flow path and upstream from a second part of the primary side flow path within the heat transfer apparatus.

9. The power plant of claim 1, further comprising:
means for determining useful output power of the expansion power engine, a storage fluid mass flow control element, and a power regulator;
wherein the power regulator is operated with the useful output power of the expansion power engine as a controlled variable and with position of the storage fluid mass flow control element as a manipulated variable.

10. The power plant of claim 1, wherein the expansion power engine is a turbine.

11. The power plant of claim 10, further comprising:
a fuel mass flow control element for controlling fuel mass flow to the atmospheric combustion chamber, means for determining temperature at the turbine inlet, and a temperature regulator;
wherein the temperature regulator is operated with temperature at the inlet as a controlled variable and with position of the fuel mass flow control element as a manipulated variable.

12. The power plant of claim 1, further comprising:
a fuel mass flow control element for controlling fuel mass flow to the atmospheric combustion chamber;
means for determining exhaust gas temperature on a downstream end of the primary side flow path of the heat transfer apparatus; and
a temperature regulator;
wherein the temperature regulator is operated with the exhaust gas temperature as a controlled variable and with position of the fuel mass flow control element as a manipulated variable.

13. The power plant of claim 1, further comprising:
a fuel mass flow control element for controlling fuel mass flow to the atmospheric combustion chamber;
means for determining at least one selected from the group consisting of flue gas temperature at a catalyst inlet and catalyst temperature; and
a temperature regulator;
wherein the temperature regulator is operated with at least one selected from the group consisting of the flue gas temperature and the catalyst temperature as a controlled variable; and
wherein the temperature regulator is operated with position of the fuel mass flow control element as a manipulated variable.

14. The power plant of claim 1, wherein a high-pressure combustion chamber is disposed downstream from the secondary side flow path of the heat transfer apparatus and upstream from the high-pressure side of the power engine.

15. The power plant of claim 14, wherein a flue gas purification catalyst is disposed at the upstream end of the primary side flow path of the heat transfer apparatus.

16. The power plant of claim 14, further comprising:
means for determining temperature at the power engine inlet on the high-pressure side of the power engine;
a fuel mass flow control element for controlling fuel mass flow to the combustion chamber; and
a temperature regulator;
wherein the temperature regulator is operated with the temperature at the power engine inlet as a controlled variable and with position of the fuel mass flow control element as a manipulated variable.

17. A method of operating a power plant comprising:
removing a storage fluid mass flow from a storage volume;
guiding the storage fluid mass flow through a secondary-side flow path of a heat transfer apparatus and heating the storage fluid mass flow thereby through indirect heat transfer;
depressurizing the heated storage fluid mass flow in an expansion engine;
sending the expanded storage fluid mass flow into an atmospheric combustion chamber;
supplying a fuel mass flow to the expanded storage fluid mass flow in the atmospheric combustion chamber and burning it, thereby generating a flue gas; and
passing the flue gas through a primary-side flow path of the heat transfer apparatus, thereby cooling the flue gas by heat exchange with the storage fluid flowing through the secondary-side flow path of the heat transfer apparatus.

18. The method of claim 17, wherein the storage fluid mass flow is an air mass flow.

19. The method of claim 17, further comprising regulating temperature of the storage fluid at an inlet to the expansion engine.

20. The method of claim 17, further comprising limiting temperature of the storage fluid at an inlet to the expansion engine to a maximum level.

21. The method of claim 17, further comprising regulating temperature of the flue gas at an outlet from the primary-side flow path of the heat transfer apparatus.

22. The method of claim 17, further comprising regulating temperature of the flue gas at an outlet from the primary-side flow path of the heat transfer apparatus to a minimum level.

23. The method of claim 16, further comprising regulating temperature of the flue gas at the inlet to a catalyst.

24. The method of claim 17, further comprising regulating temperature of a catalyst.

25. The method of claim 17, further comprising of limiting temperature of the flue gas at the inlet to within a range that is above a minimum level and below a maximum level.

26. The method of claim 17, further comprising using the fuel mass flow to the atmospheric combustion chamber-as a manipulated variable for a control circuit.

27. The method of claim 17, further comprising: determining useful output power of the expansion engine and regulating the useful output power, with the storage fluid mass flow as a manipulated variable.

28. A power plant comprising a pressure storage area for a compressed gaseous storage fluid, an expansion power engine with a power engine inlet on a high-pressure side and a power engine outlet on a low-pressure side, a heat transfer apparatus comprising a flow path on a primary side that releases heat and a flow path on a secondary side that takes up heat, and an atmospheric combustion chamber downstream of the expansion power engine, wherein:
an upstream end of the secondary side flow path of the heat transfer apparatus is connected to the pressure storage area;
a downstream end of the secondary side flow path of the heat transfer apparatus is connected to the power engine inlet; and
the power engine outlet is connected to an upstream end of the atmospheric combustion chamber.

29. A method of operating a power plant comprising:
removing a storage fluid mass flow from a storage volume;
guiding the storage fluid mass flow through a secondary-side flow path of a heat transfer apparatus and heating the storage fluid mass flow thereby through indirect heat transfer;
depressurizing the heated storage fluid mass flow in an expansion engine;
sending the expanded storage fluid mass flow into an atmospheric combustion chamber downstream of the expansion engine;
supplying a fuel mass flow to the expanded storage fluid mass flow in the atmospheric combustion chamber and burning it, thereby generating a flue gas; and
passing the flue gas through a primary-side flow path of the heat transfer apparatus, thereby cooling the flue gas by heat exchange with the storage fluid flowing through the secondary-side flow path of the heat transfer apparatus.
